(19) United States
(12) Patent Application Publication
(10) Pub. No.: US 2025/0111316 A1
(43) Pub. Date: Apr. 3, 2025

(54) SYSTEMS, METHODS, AND DEVICES FOR ASSESSING MEETING EMISSIONS

(71) Applicant: Tergo, LLC, Phoenix, AZ (US)

(72) Inventor: Thuy N. Nguyen, Gdynia (PL)

(21) Appl. No.: 18/480,448

(22) Filed: Oct. 3, 2023

(51) Int. Cl. G06Q 10/0635

(52) U.S. Cl. CPC G06Q 10/0635

(57) ABSTRACT

An example method for execution by a computer-based system includes the step of collecting data associated with attendance in a virtual meeting hosted on a virtual meeting platform by a user account associated with an entity. The system calculates an actual emissions value of the virtual meeting based on the data associated with the attendance in the virtual meeting. A baseline emissions value of a corresponding in-person meeting is estimated based on the data associated with the attendance in the virtual meeting. The system calculates an emissions reduction by subtracting the actual emissions value of the virtual meeting from the baseline emissions value of the corresponding in-person meeting, and the system ingests the actual emissions value of the virtual meeting, the baseline emissions value, and the emissions reduction into a carbon accounting database accessible by the entity.

### FIELD

The present application relates to carbon emissions and, in particular, to evaluating the environmental impact of meetings.

### BACKGROUND

Human behavior impact on the environment is sometimes quantified in terms of carbon footprint. An individual's carbon footprint may be described as the amount of carbon dioxide produced by that individual's activities. Individuals can expand or reduce their carbon footprint by making behavioral decisions that increase or reduce carbon dioxide generation. However, most individuals lack a quantitative sense of how their decisions impact the environment. Even individuals who do understand their ever-changing carbon footprint still might lack a personally meaningful incentive to behave in a more environmentally friendly manner and reduce their carbon footprint.

Corporate behavior is trending towards more socially and environmentally conscientious decisions as investors and the public become more sensitive to social and environmental issues. Companies often seek out environmentally friendly activities and investments that deviate from their core competencies. For example, a datacenter might create solar fields and wind farms by generating electricity from alternative fuel sources to offset their electricity consumption. The availability of eco-friendly behaviors for companies remains limited, and companies have little to no way to measure or respond to their corporate emissions (e.g., scope 1, scope 2, and scope 3 emissions). The company emissions (e.g., carbon footprint) of meetings can vary greatly with the rise of online meeting tools like those offered under the trade names Zoom® and Teams®. In some regions of the world, the company emissions can be tied to mandatory emissions compliance.

### SUMMARY

Systems, devices, methods, and articles are described herein for assessing carbon emissions associated with meetings. An example method for execution by a computer-based system includes the step of collecting data associated with attendance in a virtual meeting hosted on a virtual meeting platform by a user account associated with an entity. The system calculates an actual emissions value of the virtual meeting based on the data associated with the attendance in the virtual meeting. A baseline emissions value of a corresponding in-person meeting is estimated based on the data associated with the attendance in the virtual meeting. The system calculates an emissions reduction by subtracting the actual emissions value of the virtual meeting from the baseline emissions value of the corresponding in-person meeting, and the system ingests the actual emissions value of the virtual meeting, the baseline emissions value, and the emissions reduction into a carbon accounting database accessible by the entity.

In various embodiments can include a processor and a tangible, non-transitory memory configured to communicate with the processor. The tangible, non-transitory memory can store instructions thereon that, in response to execution by the processor, cause the computer-based system to perform operations. Some examples include an article of manufacture comprising a non-transitory, tangible computer readable storage medium. The storage medium can store instructions thereon that, in response to execution by a computer-based system, cause the computer-based system to perform operations.

In various embodiments, a carbon emissions report is generated for the entity. The carbon emissions report includes the actual emissions value of the virtual meeting, the baseline emissions value of the corresponding in-person meeting, and the emissions reduction. An emissions interface can be hosted and can include a graphical representation of actual emissions values from a plurality of virtual meetings including the virtual meeting. Individuals can be aggregated into a group comprising a grouped actual emissions value, a grouped baseline emissions value, and a grouped emissions reduction over a predetermined period. An emissions interface can include a graphical representation of the group including the grouped actual emissions value, the grouped baseline emissions value, and the grouped emissions reduction over the predetermined period. The carbon accounting database can include scope 1 emissions data and scope 2 emissions data associated with the entity. A reporting interface can selectively generate an emissions report comprising the scope 1 emissions data, the scope 2 emissions data, and the actual emissions value of the virtual meeting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the illustrations.

FIG. 1 illustrates an example system for assessing and augmenting emissions data from virtual meetings, in accordance with various embodiments;

FIGS. 2A-2B illustrate an example of an emissions-accounting interface, in accordance with various embodiments;

FIGS. 3A-3C illustrate an example of an emissions-reporting interface, in accordance with various embodiments;

FIG. 4 illustrates an example of a monitoring interface, in accordance with various embodiments; and

FIG. 5 illustrates an example process for assessing emissions from virtual meetings, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized, and that logical and mechanical changes may be made without departing from the spirit and scope of the inventions. The detailed description herein is thus presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step.

Systems, methods, and devices of the present disclosure (collectively, the “System”) may operate using a web app, mobile app, tablet, wearable, smart glasses or lenses, personal computer, internet of things (IoT) device, or other devices useable to participate in a virtual meeting. A secondary application running on the server or client side uses known information about the meeting attendees and host to determine the carbon emissions saved by holding the meeting virtually rather than in person. The system can track, report on, and graphically represent emissions data enterprise wide, across teams or subsets of individuals, or at an individual level.

The system may evaluate individual meeting participants in an atomic manner. The system may evaluate several participants cumulatively by determining the difference between the estimated emissions of a virtual meeting and the estimated emissions to attend in person. Meetings or attendees may be grouped by individual over a period or by any other suitable grouping. For example, activities may be grouped hourly, daily, weekly, monthly, or annually to determine a reduction in carbon emissions over a group of meetings held by a company or team.

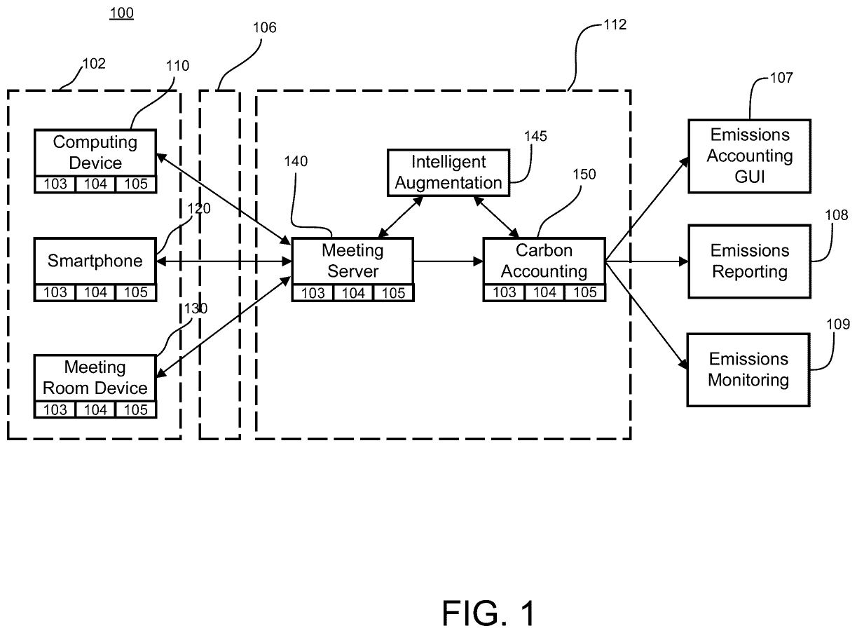

Referring now to FIG. 1, example system 100 is shown for tracking and assessing savings of carbon emissions associated with virtual meetings, in accordance with various embodiments. Users interact with system 100 through a meeting application running on client devices 102. The meeting application can be any commercially available meeting software such as, for example, those offered under the trade names ZOOM and TEAMS. Client devices 102 can include computing device 110, smartphone 120, meeting room device 130, or other devices such as a smartwatch, laptop, tablet, infotainment system, television, meeting hubs, conference bridges, suitably equipped meeting rooms, or other online device capable of participating in a virtual meeting. In some examples, a client device 102 can support a single participant, though in other examples a single client device 102 can support multiple participants in the same location. Client devices 102 typically have hardware such as processors 103, memory 104, and a network interface 105. The devices 102 will typically communicate over network 106 comprising a local-area network (LAN) or wide-area network (WAN) with meeting server 140 to participate in virtual meetings or with carbon accounting server 150 to read or write carbon accounting data. Client devices 102 can monitor bandwidth usage through network interface 105.

In various embodiments, meeting server 140, artificial intelligence (AI) augmentation system 145, and carbon accounting server 150 can comprise one or more servers, a computing cluster, virtualized computing resources, cloud computing resources, or other computing resources suitable for hosting virtual meetings. Meeting server 140, AI augmentation system, and carbon accounting server 150 can be hosted on the same device. AI Augmentation can include machine learning (ML), adaptive learning, neural network, active learning, large language systems, or other suitable AI technologies to analyze and augment emissions data described herein. AI systems can generate business intelligence (BI) that is actionable by entity 112 or business actions that are automatically implemented. Servers described herein can operate with one or more processors 103, memory 104, and a network interface 105. Servers can include permanent storage configured with storage data structures such as, for example, relational databases, unstructured data stores, data lakes, or other data structures suitable for storing and retrieving carbon accounting data.

In various embodiments, the meeting application running on client devices 102 can include plugins, scripts, user profiles, supporting applications, application programming interfaces (APIs), or other executable code to collect and store data associated with the user of client devices 102 and of associated entity 112. Relevant user data can include current location, home location, demographics, IP address, phone number, or other information useable to estimate total emissions, baseline emissions, or emissions savings, for virtual meetings. Client devices 102 can accept user input in the form of typed text or spoken word using a text interface such as, for example, keyboard, touchscreen, voice-to-text interface, or other suitable input/output devices. Third-party apps and other users may also interact with the meeting software to submit or retrieve information related to user behavior.

In various embodiments, the meeting application or supporting application can comprise a web app, native app, operating system, website, or other program capable of running on client devices device 102. The operating system may manage resources of the computing and provides common services between applications executing on the processor of a computing device. The operating system may be stored in a storage component, memory, or a combination thereof. Operating systems may vary between computing devices and may be configured to control the hardware components for the associated computing device. The meeting application and/or other programs running on client devices 102 may include programs written in a programming language such as, for example, Go, NODE.JS®, JAVA®, KOTLIN®, Solidity, or any other programming language.

In various embodiments, client devices 102 may include or interface with one or more interface devices for input or output such as a keyboard, mouse, track ball, touch pad, touch screen, and/or display. Client devices 102 can include a camera that can be polled or otherwise monitored to determine camera state (e.g., on/off). Client devices 102 may also include memory 104 in electronic communication with its respective processor 103. Processors 103 may include one or more microprocessors, co-processors, logic devices, and/or the like. A processor may comprise multiple microprocessors may execute in parallel or asynchronously. A logic device may include, for example, analog-to-digital converters, digital-to-analog converters, buffers, multiplexers, clock circuits, or any other peripheral devices required for operation of the processor. Memory may include a single memory device or multiple memory devices and may be volatile memory, non-volatile memory, or a combination thereof. In some embodiments, a non-transitory memory 104 is configured to store instructions that, when executed by the processor, cause the processor to perform the operations described herein.

In various embodiments, a client devices 102 may also comprise a storage interface in electronic communication with the processor. The storage interface may be configured to provide a physical connection to the storage component. For example, in response to a storage component comprising an internal hard drive or solid-state drive, a storage interface may include, for example, appropriate cables, drivers, and the like to enable the physical connection. As a further example, in response to the storage component comprising a removable storage medium, such as a CD-ROM drive, DVD-ROM drive, USB drive, memory card, and the like, the storage interface may comprise an interface, a port, a drive, or the like configured to receive the removable storage medium and any additional hardware and/or software suitable for operating the interface, the port, the drive, or the like.

In various embodiments, network interface 105 may comprise, for example, a serial communication port, a parallel communication port, an Ethernet communication port, a wireless adapter, or the like. A computing device may comprise network interface 105 in electronic communication with the respective processor 103 to enable electronic communication by client device 102 on network 106. A communication medium may include a physical cable such as an Ethernet cable. Network interface 105 may be configured for wireless communication via infrared, radio frequency (RF), optical, BLUETOOTH®, cellular, dedicated IoT channels, or other suitable electromagnetic or wireless communication methods. Network interface 105 may comprise one or more antennas configured to enable communication over free space. A network 106 suitable for passing communication between computing devices may be, for example, an intranet, the Internet, an internet protocol network, or a combination thereof. Each client device 102 of system 100 may communicate with meeting server 140, carbon accounting server 150, or other client devices 102, either directly or indirectly via a network.

In various embodiments, entity 112 can have partitioned resources on meeting server 140 or carbon accounting server 150. The partitioned resources can be private instances of meeting rooms that are accessible to people associated with entity 112 or otherwise authorized by entity 112. Entity 112 can also control access to outputs from carbon accounting server 150 including access to emissions accounting GUI 107, emissions reporting 108, emissions monitoring 109, or other outputs of carbon accounting server 150 as described below.

In various embodiments, meeting server 140 can host meetings with multiple participants physically separated from one another. Each participant can set up a user profile associated with their user account, can log into the meeting application with a client device 102, and can participate in a virtual meeting. A plugin or other secondary application can estimate the total emissions, baseline emissions, and emissions saved by holding the meeting virtually rather than holding the meeting in person. Meeting server 140 can run the secondary application, or client devices 102 can run the secondary application, or carbon accounting server 150 can run the secondary application.

In various embodiments, an estimate is generated for the emissions cost of hosting a corresponding in-person meeting. The in-person estimate can be based on the location of client devices 102 participating in the meeting. Location can be determined based on the IP address of the respective client devices 102. Location can be determined using GPS. Location can be determined based on user data manually entered and associated with a user account or company account authenticated with meeting server 140.

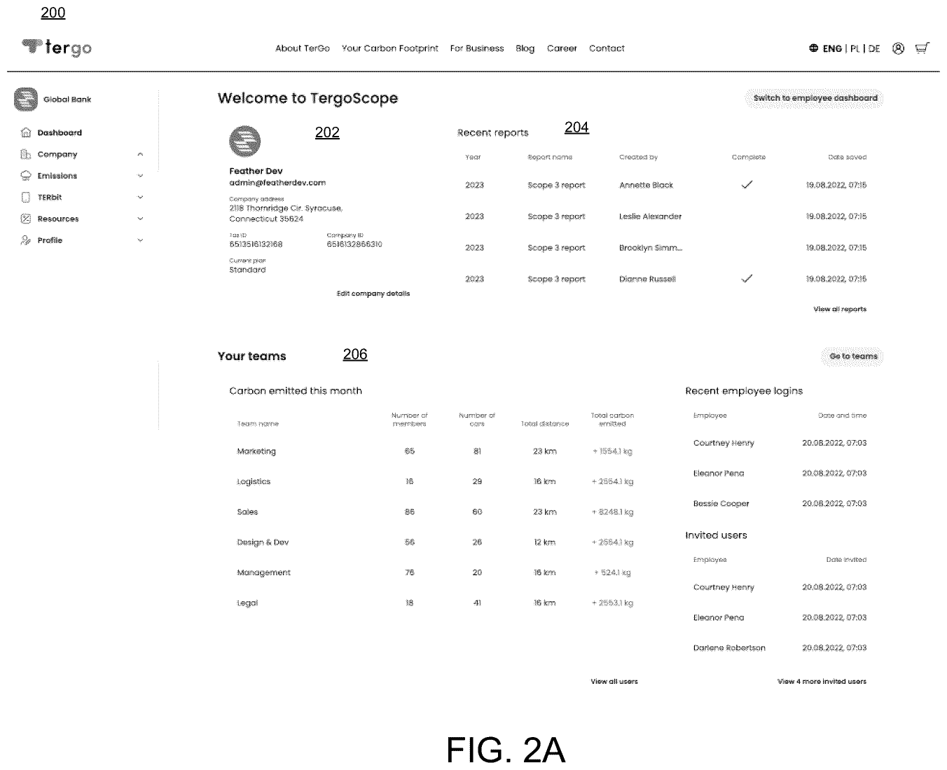

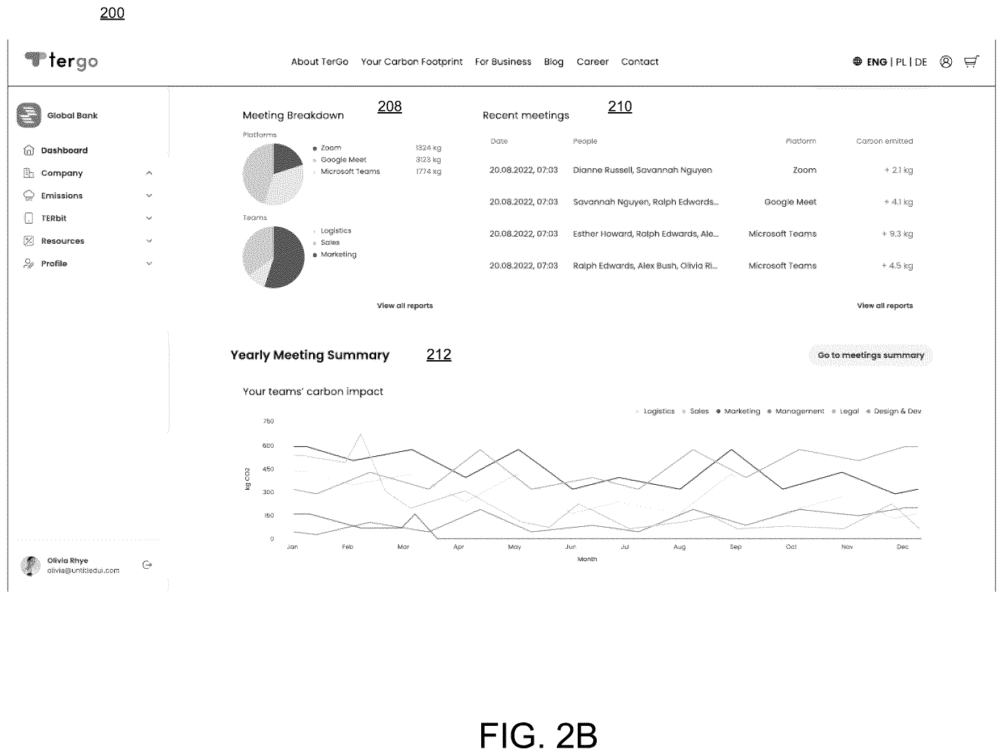

Referring now to FIGS. 2A and 2B, an emissions-accounting interface 200 is shown, in accordance with various embodiments. Interface 200 can include account information 202 for the authenticated user account accessing interface 200. For example, account information 202 can include username, account identifier (ID), company name, company address, tax identification, company identification, plan status, or other company or user details. Interface 200 can include data visualization tools such as, for example, report history 204. Report history 204 can include an index of reports run and can display report parameters such as, for example, report period, report name, report creator, request date and time, and report status.

In various embodiments, interface 200 may include company-wide emissions 206 detailing carbon emissions across the company by various groupings. Company users can be grouped by team, by individual, by home facility, by home region, or other grouping suitable to assess company-wide carbon emissions. Company-wide emissions 206 can aggregate and display emissions data for the groupings along with a grouping ID. Suitable emissions data for aggregation and display can include the number of individuals in the grouping (e.g., team members), the number of cars owned by or assigned to the grouping, the total distance to the work facility of the grouping, and the total carbon emitted from the grouping. Emissions data can include meeting emissions data, or other emissions data not directly related to meetings. For examples of emissions data suitable for integration into carbon accounting systems described herein, see U.S. Pat. No. 11,694,258, which is incorporated herein by reference for any purpose.

In various embodiments, emissions-accounting interface 200 includes meeting breakdown 208. Meeting breakdown 208 can include data identifying meeting software used by client devices 102 authenticated to meeting servers 140 as being part of entity 112. Meeting breakdown can include a graphical representation of usage (e.g., a pie chart) along with the emissions expended or saved using each platform. Different platforms can have different emissions savings for the same or similar meetings due to different underlying emissions attributable to the meeting software provider. The attributable emissions can include actual emissions or estimated emissions, and the attributable emissions can be reduced by actual offsets or estimated offsets attributable to the meeting company.

In various embodiments, interface 200 may include a listing of meetings 210. The listing of meetings may be sorted, for example, by most recently started, most recently completed, largest or smallest emissions cost, largest or smallest emissions savings, time of day, duration of meeting, participation time of participants, or other suitable parameters. Parameters may be used to simulate meetings and suggest meeting parameters for improved emissions totals, emissions baselines, or emissions savings. Information displayed and related to recent meetings can include participants from entity 112, participants from outside entity 112, meeting platform used, carbon emissions resulting from the meeting, carbon emissions reduced by the meeting compared to in person, the date and time of the meeting, or other meeting metadata of interest.

In various embodiments, emissions-accounting interface 200 can also include yearly, monthly, daily, hourly, seasonal, quarterly, regional, or location-based meeting summary 212. A yearly meeting summary 212, for example, may include visual representations of emissions attributable to entity 112 (e.g., line graphs or other graphical representations). Yearly meeting summary 212 can include emissions data for groups within entity 112 or individuals. Yearly meeting summary 212 can plot the emissions savings or emissions caused against the month, for example, to produce a line graph comparing relative performance of different groups. Grouping data can be aggregated and normalized based on the size of a group (e.g., per capita numbers for groupings).

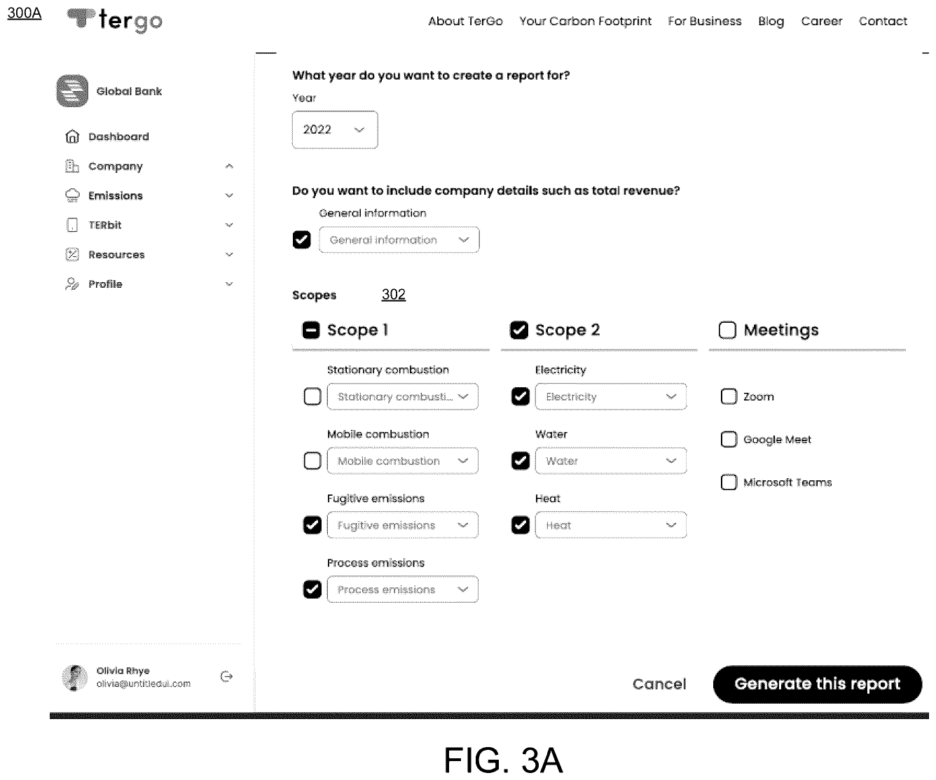

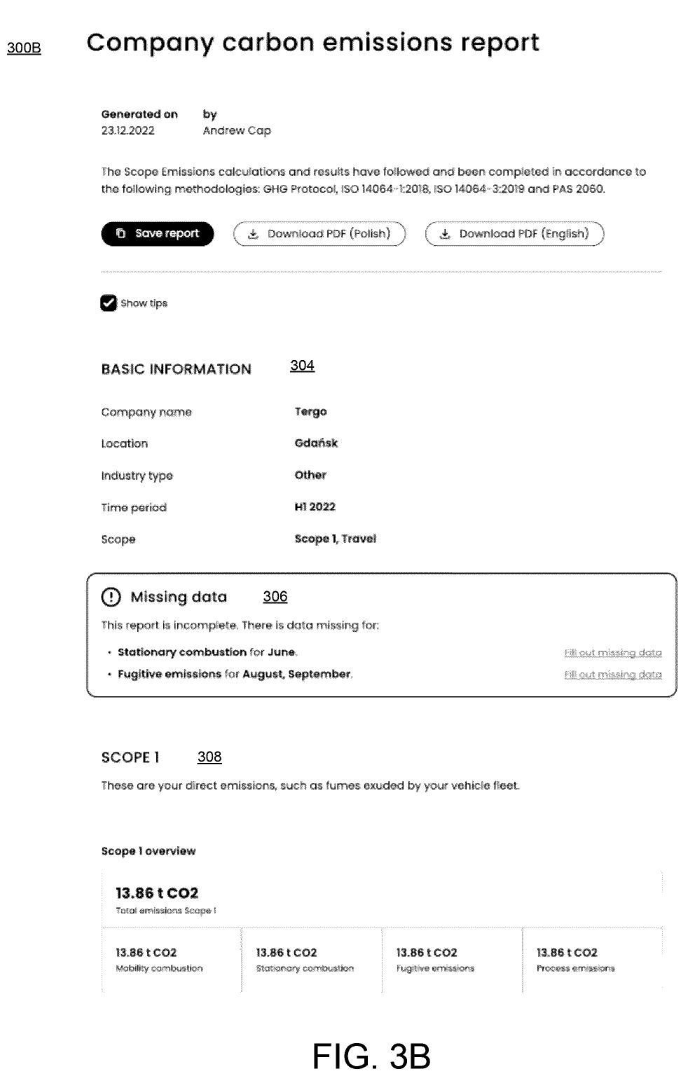

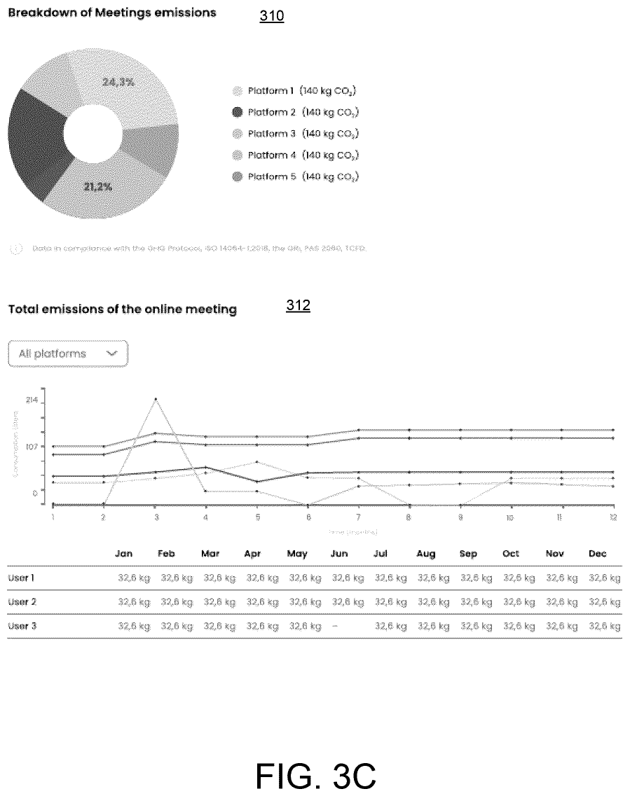

Referring now to FIGS. 3A through 3C, a reporting interface 300 is shown, in accordance with various embodiments. The example of FIG. 3A shows a report generation interface 300A. Interface 300A can be used to generate emissions reports for entity 112. Interface 300A can configure reports for a reporting period (e.g., a year, month, between start and end dates, compliance period, or another suitable period). Interface 300A can be configured to include company data or user data in the output reports. Scope 302 of the report can be set to include scope 1 emissions, scope 2 emissions, scope 3 emissions, meeting emissions, or other types of emissions. Report scope 302 can also be set to include subcategories of top-level emissions scopes. Reports can further be configured based on meeting application used to host virtual meetings.

Referring now to FIGS. 3B and 3C, an example of emissions report 300B is shown, in accordance with various embodiments. Emission report 300B can include basic information 304 about entity 112 or a user authenticated to meeting server 140 or carbon accounting server 150. Emissions report 300B can include emissions data associated with entity 112 and retrieved from emissions accounting server 150 in response to a reporting request. Reporting requests can come from reporting interface 300, for example, or can be automatically triggered by a reporting schedule or configurable reporting settings.

In various embodiments, report 300B may include basic information such as a name of entity 112, a primary place of business or headquarters location, industry type, reporting period, report scope, or other basic identifying information for report 300B.

In various embodiments, emission report 300B may flag missing data 306. Missing data 306 can be data expected within scope 302 of the report but not present in data retrieved from emissions accounting server 150. Types of missing data 306 can include top-level categories (e.g., scope 1, scope 2, scope 3, meetings) or subcategories (e.g., stationary combustion, mobile combustion, fugitive emissions, process emissions, electricity, water, heat, ZOOM, TEAMS, MEET, groupings within entity 112, missing periods, or other identifiable categories of data). Missing data 306 flags can indicate to entity 112 that a check should be made for missing data to validate report 300B.

In various embodiments, report 300B can include emissions data 308. Emissions data 308 can be sorted by scope 302 categories. In the examples of FIG. 3B, scope 1 data is shown, though other embodiments could include meeting emissions data, scope 2 emissions data, or other emissions data. The example of FIG. 3C shows visual representations of meeting data suitable for emissions report 300B.

In various embodiments, meeting breakdown 310 can include a graphical representation of usage (e.g., a pie chart) along with the emissions expended or saved using each platform. Total emissions 312 can be displayed in tabular or graphical form. In the example of FIG. 3C, total emissions 312 are reported graphically in the form of a line graph. Total emissions 312 can include emissions information for individual users associated with entity 112 or groupings of users associated with entity 112. Meeting emissions can be plotted with carbon emissions (or savings) resulting from virtual meetings versus time (e.g., hours, days, weeks, months, years, etc.).

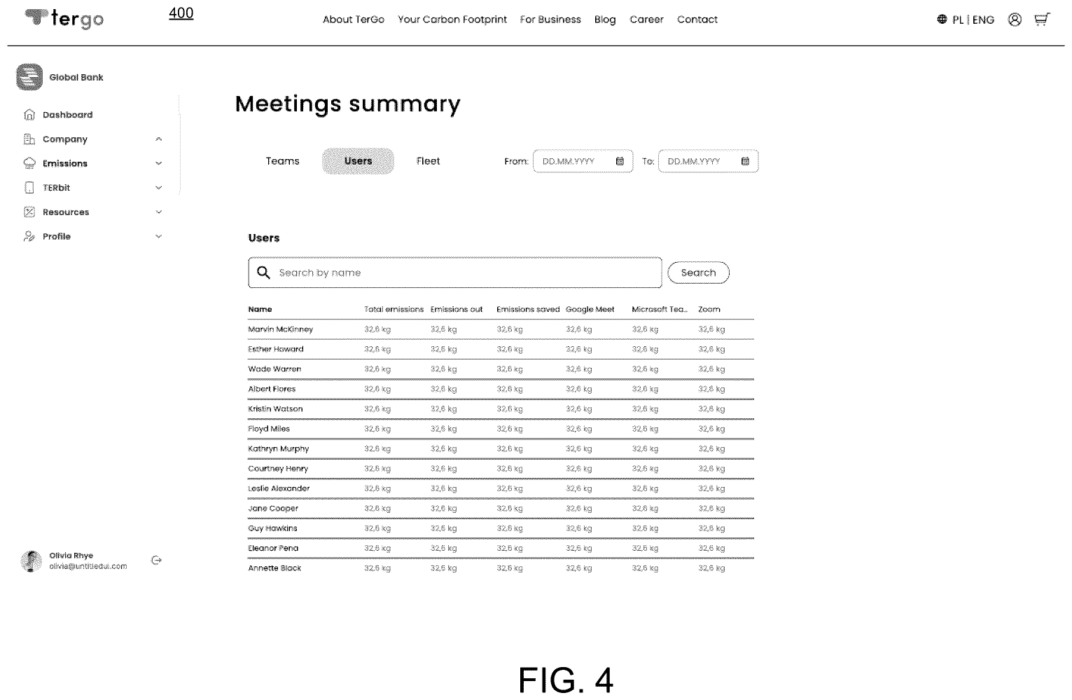

Referring now to FIG. 4, an example interface 400 for emissions monitoring is shown, in accordance with various embodiments. In the example of FIG. 4, interface 400 can monitor emissions on an individual, team, or entity-wide basis. Relevant emissions data can be retrieved, filtered, and sorted according to user preferences. Emissions data included in interface 400 can comprise total emissions, emissions output, emissions baselines, emissions savings versus in-person meetings, or emissions saved (or output) by platform such as, for example, emissions data captured for meetings using the platforms available under the tradenames TEAMS, ZOOM, MEET, or other suitable virtual meeting platforms.

In various embodiments, the data can be filtered by date ranges, by user groupings, or by data values. In some examples, data can be searchable by a user, group, or other identifier. Although the example in FIG. 4 uses 32.6 kilograms (kg) as an example for each emission data column, typical emissions data will vary.

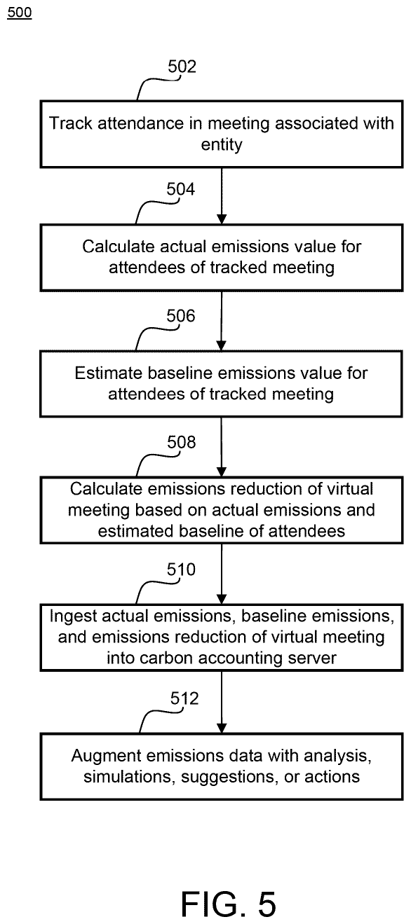

Referring now to FIG. 5, an example process 500 is shown for assessing emissions associated with virtual meetings. Process 500 may begin by tracking meeting attendance at meetings associated with an entity (Block 502). Meetings associated with an entity can include internal meetings, vendor meetings, client meetings, or any other meeting including an attendee associated with the entity (e.g., an employee, contractor, or consultant). In some examples, social meetings employees and their families, awards ceremonies, social showings of films, educational training, or other types of meetings can be included. Attendees associated with entity 112 can be identified by email address, by user login, by meeting location (e.g., in a meeting room at a facility of entity 112), or using other identifying information. Meeting server 140 can identify meeting attendees associated with entity 112, or client devices 102 can identify meeting attendees associated with entity 112.

In various embodiments, meetings including at least one attendee associated with entity 112 can be tracked and included in meeting emissions data for entity 112. In that regard, third-parties or other individuals not otherwise associated with entity 112 can be included in meeting emissions data for a meeting hosted by or otherwise with entity 112. Some examples can keep third-party emissions data in a separate third-party grouping of individuals separate from the entity's fleet data.

In various embodiments, system 100 may determine the actual emissions for attendees of tracked meetings (Block 504). Various factors can be used to determine the carbon emissions incurred in support of a virtual meeting. Examples of relevant factors may include duration of the meeting, bandwidth consumption for the meeting from each participant, video status (i.e., on or off), number of participants, location of participants, type of client devices 102 used, power consumption of client devices 102 used, electricity consumption-emission factors, type of meeting (e.g., business meeting, event, or conference), supporting applications used during the meeting (e.g., recording meeting app), or other factors that can impact emissions. Bandwidth use for a meeting can be calculated based on the number of participants and video quality configuration or bitrate used by participants. Some examples can consider the percentage of renewable energy used to support the meeting, which can be determined based on participant locations and energy mixtures at the participant locations.

In various embodiments, data can be automatically detected or entered by users, and the collected data can be used to calculate the emissions for a meeting attendee (meet_emis_ind). In some examples, factors used to determine individual emissions may include: duration of the meeting in minutes (meet_dur); internet consumption for the meeting from each participant (meet_net_cons); video on or off (meet_vid_stat); number of participants (meet_part_no); participant location (meet_part_loc_elec); power consumption of client device 102 based on the device type (meet_dev_cons); electricity-consumption-emission factors (meet_elec_cons); type of meeting (e.g., business meeting, event, or conference) (meet_type); other apps used during the meeting (e.g., recording meeting app) (meet_rcord_stat); or the percentage of renewable energy (meet_re_p).

Continuing the example, meet_net_cons can be set based on the status of the video flag (meet_vid_stat) and the recording flag (meet_rcord_stat). For example, if both are on then internet consumption might be 16 MB; if video is on and recording is off then internet consumption might by 8 MB; if video is off and recording is off then internet consumption might be 0.09 MB; or if video is off and recording is on then internet consumption might be 0.15 MB. Meeting duration and the type of client device 102 can be entered by a user or determined automatically to determine the electricity-consumption-emission factor for each user and client device. For example, meet_elec_cons can be equal to meet_dur*(meet_dev_cons+0.00075). The electricity function can be predetermined for device type. For example, a personal computer might consume about 0.0015 KWh/minute, a laptop might consume about 0.0005 KWh/minute, a tablet might consume about 0.00017 KWh/minute, a smartphone might consume about 0.000083 KWh/minute. WIFI equipment might consume about 0.00075 KWh/minute to maintain internet access, and online streaming might consume about 0.03 kg CO2/MB. As used herein with quantities of electricity consumption or carbon emissions, the term about can mean+/−5%, +/−10%, +/−15%, +/−20%, or +/−25%.

In various embodiments, the individual meeting emissions can be calculated using an aggregation function. Continuing the above example, meet_emis_ind can be equal to ((meet_elec_cons*meet_part_loc_elec)*(1−meet_re_p)+(meet_elec_cons*0.0022)*(meet_re_p))+((meet_dur*meet_net_cons)*0.03). The total emissions for a virtual meeting can be determined by summing the emissions of each individual attendee along with any more broadly attributable (e.g., meeting-wide) emissions. Examples of meeting-wide emissions can include emissions attributable to recording apps, third-party apps, or other emissions sources not wholly attributable to an individual attendee.

In various embodiments, system 100 establishes a baseline value for attendees of tracked meetings (Block 506). A baseline value can comprise an estimated in-person emissions value for each attendee at the meeting. The baseline emissions value may be determined by projecting the estimated emissions cost to travel from the meeting attendee's location to the location of the meeting host or of another potential in-person meeting location. In some examples, baseline emissions values can be determined by analyzing regional emissions (e.g., country, province, state, county, or other geographic grouping) or world-wide emissions to estimate baseline values. In some examples, ML or AI techniques can be used to estimate baseline values for individuals depending on location, demographics, or other data. Baseline values can be influenced by time of day, time of year (e.g., month or season), weather, or other factors. Factors used in calculating actual emissions can also be used to estimate an emissions baseline. Client device 102 used by an attendee can send its IP address or other location data to meeting server 140. The IP address can be used to determine the location of the meeting attendee during the virtual meeting.

In various embodiments, the baseline value can be determined by calculating an emission value of a reasonable travel itinerary from the attendee's location to the meeting location. A reasonable travel itinerary can include public transit, automobile, aircraft, or other transportation mediums depending on the difference between the attendee's location and the would-be in-person meeting location. For example, a reasonable itinerary for an attendee based in Arizona of a meeting located in Poland could include automobile travel to the airport, and a flight, to Warsaw, and public transit to a meeting location. The baseline emissions value of each leg can be determined based on the vehicle used for travel and the distance covered. The total emissions baseline for the attendee can comprise the sum of the emissions baseline for each estimated leg of travel.

Several factors can be used to determine the baseline emission value, also referred to as real meeting emissions value (meet_real). For example, the type of transportation that an attendee would likely use instead of attending the online/virtual meeting (meet_real_trns) is used to determine the baseline emissions value. In some examples, attendees can specify the transportation they would take, particularly for long distance or international participants. Another example factor is the host meeting space size, which can be determined based on the type of meeting (meet_type). Examples of meeting types can include business meetings, events, or conferences.

In various embodiments, host location (meet_host_loc_elec) can be considered as a factor in determining the real meeting emissions, as can whether the actual meeting space would likely use heating or cooling, which may be determined based on the time of the year or season for the meeting (meet_seas). Some embodiments can include whether the actual meeting would have hospitality (meet_real_hosp) such as food or beverage.

In one example, an attendee might have a 30-kilometer (km) round trip to the would-be meeting location. The real meeting transportation emissions (meet_real_trns) would be equal to 30 km*medium gas car emissions constant (e.g., 0.23778). Continuing the example, the real meeting energy emissions (meet_real_ener) will be based on the meeting type (meet_type) selected by the user. Some examples may determine the meeting space area from a lookup table and store the resultant value in the variable (meet_type_area). Based on selecting the season of the meeting, the some embodiments can store the result in the variable (meet_seas_cool) for cooling factor and the variable (meet_seas_heat) for heating factor. Continuing the foregoing example, an example algorithm to determine real meeting energy emissions might set meet_real_ener equal to {[((meet_type_area)*0.005455)+((meet_type_area)*(meet_seas_cool))+((meet_type_area)*(meet_seas_heat))]*(meet_dur)}*(meet_host_loc_elec).

In various embodiments, the total real meeting emissions can be determined by aggregating the various factors taken into consideration. For example, meet_real can be equal to meet_real_trns+meet_real_ener+meet_real_hosp. The total emissions saved can then be the difference between the real meeting emission value (e.g., the baseline for to hold the meeting in-person) and the total emissions of the virtual meeting.

In various embodiments, a reasonable travel itinerary can be based in part on duration of meetings over a predetermined period of hours, day, weeks, etc. For example, for most 30-minute meetings, a flight across the Atlantic Ocean might be considered unreasonable when the attendee could accomplish the meeting goals telephonically or virtually. However, a brief drive in town might be reasonable for the same 30-minute meeting. In some examples, system 100 applies a cumulative meeting time total to determine whether a flight would be reasonably included in a travel itinerary for an individual attendee. Some embodiments can determine include maximum drive times per duration of meetings in a predetermined period.

In various embodiments, considerations in determining the baseline emissions value can include the type of transportation that would carry the attendee to the in-person meeting, size of the in-person meeting space, location of the in-person meeting space (e.g., host location), heating or cooling used in the location, time of the year for the meeting (e.g., season-summer, winter, fall, spring), or hospitality type available in for the meeting.

In various embodiments, system 100 can calculate the emissions reduction of the virtual meeting based on the actual emissions values and estimated baseline values of attendees (Block 508). The emission reduction or emission savings of each individual attendee is the difference between the individual's actual emissions value and the individual's baseline emissions value. Emissions reductions for the virtual meeting can be calculated by summing the emissions reduction of individual attendees along with any broader emissions associated with the meeting but not attributable to a single individual (e.g., emissions from running a third-party recording app). The actual emissions, the baseline emissions, and the emissions reduction for individual attendees, and for the broader meeting, can be calculated at by client devices 102, meeting server 140, or emissions carbon accounting server 150.

In various embodiments, system 100 ingests actual emissions, baseline emissions, and emissions reduction values of individual attendees and of the virtual meeting (Block 510). The actual emissions, baseline emissions, and emissions reduction values can be processed at regular intervals or on demand to generate reports or interfaces described herein. In some examples, notifications are automatically sent to an admin account in response to threshold emissions values being hit by individuals, teams, or across an enterprise. Some embodiments can send messages to individuals or teams recommending conservation techniques for meetings such as holding more meetings virtually, turning off video, turning off recording, or otherwise suggesting settings to reduce bandwidth consumption of virtual meetings.

In various embodiments, system 100 can augment emissions data (Block 512), in accordance with various embodiments. AI augmentation 145 can be trained and applied to analyze emissions data for potential emissions savings opportunities. AI augmentation 145 can run simulations to determine the emissions cost or savings of changes to behavior in entity 112. AI augmentation 145 can make suggestions for behavior modification, for meeting configuration, or for meeting policies that can save emissions for the entity. In some examples, AI augmentation 145 can take actions by directly modifying virtual meeting configurations, entity requirements for employees to setup virtual meetings, implementing suggestion screens for employees and affiliated meeting hosts during setup, or otherwise acting within limitations to reduce emissions of entity 112.

Systems of the present disclosure may educate and inform users and entities about their CO2 emissions, reduction methods of CO2 emissions and other CO2 emission possibilities, whether in the present meeting or during a future meeting. Recommendations or policy changes can be made in real time or near real time. Systems described herein tend to improve carbon emissions savings from in-person or virtual meetings. Carbon accounting integration automates emissions tracking for meetings and can generate reports on demand or on a regular schedule. AI augmentation can generate business intelligence or otherwise take action to improve emissions savings for meetings associated with the associated entity.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Devices, systems, and methods are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. A method comprising:
collecting, by a computer-based system, data associated with attendance in a virtual meeting hosted on a virtual meeting platform by a user account associated with an entity;
calculating, by the computer-based system, an actual emissions value of the virtual meeting based on the data associated with the attendance in the virtual meeting;
estimating, by the computer-based system, a baseline emissions value of a corresponding in-person meeting based on the data associated with the attendance in the virtual meeting;
calculating, by the computer-based system, an emissions reduction by subtracting the actual emissions value of the virtual meeting from the baseline emissions value of the corresponding in-person meeting; and
ingesting, by the computer-based system, the actual emissions value of the virtual meeting, the baseline emissions value, and the emissions reduction into a carbon accounting database accessible by the entity.

2. The method of claim 1, further comprising generating a carbon emissions report for the entity, wherein the carbon emissions report includes the actual emissions value of the virtual meeting, the baseline emissions value of the corresponding in-person meeting, and the emissions reduction.

3. The method of claim 1, further comprising hosting an emissions interface comprising a graphical representation of actual emissions values from a plurality of virtual meetings including the virtual meeting.

4. The method of claim 1, further comprising aggregating a plurality of individuals into a group comprising a grouped actual emissions value, a grouped baseline emissions value, and a grouped emissions reduction over a predetermined period.

5. The method of claim 4, further comprising hosting an emissions interface comprising a graphical representation of the group including the grouped actual emissions value, the grouped baseline emissions value, and the grouped emissions reduction over the predetermined period.

6. The method of claim 1, wherein the carbon accounting database further comprises scope 1 emissions data and scope 2 emissions data associated with the entity.

7. The method of claim 6, further comprising hosting a reporting interface to selectively generate an emissions report comprising the scope 1 emissions data, the scope 2 emissions data, and the actual emissions value of the virtual meeting.

8. A computer-based system, comprising:
a processor; and
a tangible, non-transitory memory configured to communicate with the processor, the tangible, non-transitory memory having instructions stored thereon that, in response to execution by the processor, cause the computer-based system to perform operations comprising:
collecting, by the computer-based system, data associated with attendance in a virtual meeting hosted on a virtual meeting platform by a user account associated with an entity;
calculating, by the computer-based system, an actual emissions value of the virtual meeting based on the data associated with the attendance in the virtual meeting;
estimating, by the computer-based system, a baseline emissions value of a corresponding in-person meeting based on the data associated with the attendance in the virtual meeting;
calculating, by the computer-based system, an emissions reduction by subtracting the actual emissions value of the virtual meeting from the baseline emissions value of the corresponding in-person meeting; and
ingesting, by the computer-based system, the actual emissions value of the virtual meeting, the baseline emissions value, and the emissions reduction into a carbon accounting database accessible by the entity.

9. The computer-based system of claim 8, wherein the operations further comprise generating a carbon emissions report for the entity, wherein the carbon emissions report includes the actual emissions value of the virtual meeting, the baseline emissions value of the corresponding in-person meeting, and the emissions reduction.

10. The computer-based system of claim 8, wherein the operations further comprise hosting an emissions interface comprising a graphical representation of actual emissions values from a plurality of virtual meetings including the virtual meeting.

11. The computer-based system of claim 8, wherein the operations further comprise aggregating a plurality of individuals into a group comprising a grouped actual emissions value, a grouped baseline emissions value, and a grouped emissions reduction over a predetermined period.

12. The computer-based system of claim 11, wherein the operations further comprise hosting an emissions interface comprising a graphical representation of the group including the grouped actual emissions value, the grouped baseline emissions value, and the grouped emissions reduction over the predetermined period.

13. The computer-based system of claim 8, wherein the carbon accounting database further comprises scope 8 emissions data and scope 2 emissions data associated with the entity.

14. The computer-based system of claim 13, wherein the operations further comprise hosting a reporting interface to selectively generate an emissions report comprising the scope 8 emissions data, the scope 2 emissions data, and the actual emissions value of the virtual meeting.

15. An article of manufacture including a non-transitory, tangible computer readable storage medium having instructions stored thereon that, in response to execution by a computer-based system, cause the computer-based system to perform operations, the operations comprising:
collecting, by the computer-based system, data associated with attendance in a virtual meeting hosted on a virtual meeting platform by a user account associated with an entity;
calculating, by the computer-based system, an actual emissions value of the virtual meeting based on the data associated with the attendance in the virtual meeting;
estimating, by the computer-based system, a baseline emissions value of a corresponding in-person meeting based on the data associated with the attendance in the virtual meeting;
calculating, by the computer-based system, an emissions reduction by subtracting the actual emissions value of the virtual meeting from the baseline emissions value of the corresponding in-person meeting; and
ingesting, by the computer-based system, the actual emissions value of the virtual meeting, the baseline emissions value, and the emissions reduction into a carbon accounting database accessible by the entity.

16. The article of claim 15, wherein the operations further comprise generating a carbon emissions report for the entity, wherein the carbon emissions report includes the actual emissions value of the virtual meeting, the baseline emissions value of the corresponding in-person meeting, and the emissions reduction.

17. The article of claim 15, wherein the operations further comprise hosting an emissions interface comprising a graphical representation of actual emissions values from a plurality of virtual meetings including the virtual meeting.

18. The article of claim 15, wherein the operations further comprise aggregating a plurality of individuals into a group comprising a grouped actual emissions value, a grouped baseline emissions value, and a grouped emissions reduction over a predetermined period.

19. The article of claim 18, wherein the operations further comprise hosting an emissions interface comprising a graphical representation of the group including the grouped actual emissions value, the grouped baseline emissions value, and the grouped emissions reduction over the predetermined period.

20. The article of claim 15, wherein the carbon accounting database further comprises scope 8 emissions data and scope 2 emissions data associated with the entity.
